(19) United States
(12) Patent Application Publication
(10) Pub. No.: US 2009/0000830 A1
(43) Pub. Date: Jan. 1, 2009

(54) WRITABLE ELECTRONIC BOOK

(75) Inventors: Hyun Ki Kim, Seoul (KR); Seog Guen Kim, Seoul (KR); Jung Hoom Kim, Seoul (KR); Soon Joo Kwon, Seongnam-si (KR); Hyung Ho Hwangbo, Seoul (KR); Hye Joo Lee, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/147,724

(22) Filed: Jun. 27, 2008

(30) Foreign Application Priority Data
Jun. 29, 2007 (KR) 2007-65415

(51) Int. Cl. G06F 3/041

(52) U.S. Cl. 178/18.03

(57) ABSTRACT

A writable electronic book, including a binder body, a plurality of electronic paper modules, each representing a single sheet of paper detachably coupled to the binder body, to display content, and a write panel that is included in at least one of the electronic paper modules and that overlaps at least part of a display area of the at least one of the electronic paper modules, to receive manipulation information and write information of a user via a digital pen. The write information inputted through the write panel is added to the content and is stored.

### CROSS-REFERENCE TO RELATED APPLICATIONS

This application claims all benefits accruing under 35 U.S.C. §119 from Korean Patent Application No. 2007-65415, filed in the Korean Intellectual Property Office on Jun. 29, 2007, the disclosure of which is incorporated herein by reference.

### BACKGROUND OF THE INVENTION

1. Field of the Invention

Aspects of the present invention relate to a multimedia terminal, and, more particularly, to an electronic book.

2. Related Art

An electronic book is multimedia content in which text, images, or moving pictures are combined or a dedicated terminal for reproducing such content. The term “electronic book” has conventionally referred to multimedia content, software reproduced in a personal portable terminal (such as a personal data assistant (PDA) or portable multimedia player (PMP)). Although in some cases such content support bidirectional operation, an attempt to edit or update the content by a user has not been made due to technological or copyright limitations.

A conceptual attempt to use an electronic book for learning has been made. However, there are a few requirements in using the electronic book during class in a classroom. First, the electronic book should contain materials of various subjects freely and conveniently according to curriculums. Second, students must be able to annotate the materials as is usual in class. However, there is no electronic book focused on such aspects.

Techniques for electronic paper or flexible display have been rapidly developed using liquid crystal, organic light emitting diode (OLED), or electrophoretic technology on a flexible transparent substrate such as plastic. Recently, the development of a 2.5-inch display having a thickness of 0.3 mm and a resolution of 120×169 has been announced. Moreover, multimedia devices employing electronic ink (E-ink) or electronic paper have been commercially used. A display that uses E-ink combining an electronic technology and polymer technology is similar to paper in terms of thickness and flexibility.

### SUMMARY OF THE INVENTION

Aspects of the invention provide a writable electronic book. Additional aspects of the invention provide an electronic book in which a plurality of books are integrated in one device to be naturally and conveniently used.

According to an aspect of the invention, a writable electronic book is provided. The electronic book comprises a binder body; a plurality of electronic paper modules, each representing a single sheet of paper detachably coupled to the binder body, to display content; and a write panel that is included in at least one of the electronic paper modules and that overlaps at least part of a display area of the at least one of the electronic paper modules, to receive manipulation information and write information of a user via a digital pen, wherein the write information inputted through the write panel is added to the content and is stored.

The electronic book according to the above aspect of the present invention can be written in like a general book by storing write information inputted through the write panel together with the content. Since sheets of the electronic paper modules can be added or eliminated from the body, new materials can be added. A large amount of materials can be stored in one electronic book and new content can be added by inserting sheets of electronic paper modules. Therefore, a user can interact with the electronic book like an actual paper book and can use the electronic book more naturally.

According to another aspect of the invention, each of the electronic paper modules may include a memory to store the content; a body interface to input data to the electronic paper module and output data to the body; a controller to generate display data by reading the content stored in the memory according to a manipulation command inputted from the body interface and to store write information inputted from the body interface in a corresponding region of the memory; and an electronic paper display to display the display data generated from the controller.

According to the above aspect of the present invention, since each electronic paper module store corresponding content in its own memory, content can be immediately added or eliminated without an additional operation simply by attaching or detaching the electronic paper module.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates an outer configuration of an electronic book according to an example embodiment of the present invention;

FIG. 2A is a block diagram schematically illustrating an electronic paper module according to an example embodiment of the present invention;

FIG. 2B is a block diagram schematically illustrating a body corresponding to the electronic paper module of FIG. 2A;

FIG. 2C is a block diagram schematically illustrating a write panel corresponding to the electronic paper module of FIG. 2A and the body of FIG. 2B;

FIG. 3A is a block diagram schematically illustrating an electronic paper module according to another example embodiment of the present invention;

FIG. 3B is a block diagram schematically illustrating a write panel corresponding to the electronic paper module of FIG. 3A; and

FIG. 4 is a block diagram schematically illustrating a body according to still another example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

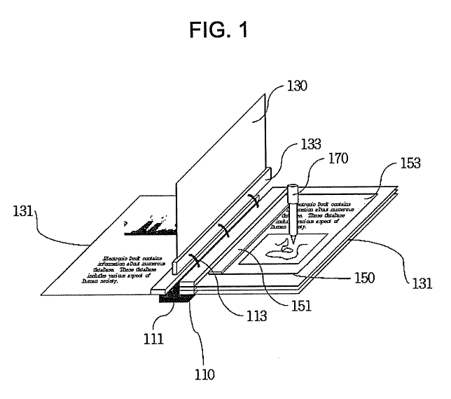

FIG. 1 shows an outer configuration of an electronic book according to an example embodiment of the present invention. The electronic book includes a plurality of electronic paper modules 130 to display content, a transparent write panel 150, and a body 110. According to other aspects of the invention, the electronic book may include additional and/or other units. Similarly, the functionality of two or more of the above units may be integrated into a single component.

The transparent write panel 150 is included in at least one of the electronic paper modules 130, overlaps at least a part of a display area, and receives manipulation information and write information from a user by recognizing an input device, such as a digital pen. The body 110 detachably affixes the electronic paper modules 130 to the electronic book. The write information inputted through the write panel 150 is added to existing content and is stored. Viewed from the outside, the electronic book has a configuration in which sheets of electronic paper modules 130 may be added or eliminated by a fixing unit 113, like a general book.

As shown in FIG. 1, the electronic paper module 130 includes a circuit unit 131 and an electronic paper display 133. The write panel 150 includes a circuit unit 151 and a pen detector 153, and the body 110 includes a fixing unit 113 and a housing 111.

The fixing unit 113 has a ring structure that can be opened or closed to fix sheets of electronic paper modules 130. The fixing unit 113 fixes the electronic paper modules 130 by threading the electronic paper modules 130 through fixing holes punched on the circuit unit 131 of each of the electronic paper modules 130. Aspects of the present invention are not limited thereto. Various modifications to the fixing unit 113 are possible, including being flexibly or tightly fixed, or a structure fixing sheets of paper as in a typical binder.

Only one write panel 150 is shown in FIG. 1. The write panel 150 is constructed to be used by overlapping the write panel 150 with one of the electronic paper modules 130. The write panel 150 communicates with the electronic paper modules 130 by near-field wireless communication. The near-field wireless communication is performed by a wireless communication unit (not shown) mounted within circuit units of two panels in close proximity. The wireless communication unit may employ wireless communication by a radio frequency (RF) antenna having a very low power, or a method of sensing a variation in capacitance between two adjacent devices or a variation in inductance of a coil. Such wireless communication between devices in close proximity is a general technology of which various methods are well known, and any method may be employed by the wireless communication unit. A plurality of write panels 150 may be provided. The write panels 150 may alternatively be integrated with the electronic paper modules 130. The write panel 150 and the electronic paper modules 130 may also be connected to the body 110 through a cable, such as a flexible printed circuit board (FPCB). The write panel 150 and the electronic paper modules 130 may communicate with each other through a relay of the body 110.

As shown in FIG. 1, communication between the electronic paper modules 130 and the body 110 is performed by wireless bus communication. In wireless bus communication, the body 110 acts as a master directing communication and the electronic paper modules 130 having unique identifications are operated as slaves. Any wireless bus structure may be employed for communication between the electronic paper modules 130 and the body 110. Since the electronic paper modules 130 and the body 110 operate by wireless bus communication, it is not necessary to add a cable connection even though a new electronic paper module is added. The new electronic paper module can be automatically registered in the body 110 by request of the slave. Nevertheless, the electronic paper modules 130 may be connected to the body 110 through a cable connection, such as an FPCB as described above. In this case, since a unique address is assigned to each cable, communication can be immediately established via the cable connection.

Aspects of the present invention are described taking as an example an electronic book used by students to take a course. A student checks a daily lecture schedule before going to school, draws out electronic paper modules 130 of necessary subjects, and binds (affixes) the electronic paper modules 130 to a body. The student attends school with a single electronic book and a digital pen, without the need for other books. During class the student opens the electronic paper module 130 of a corresponding subject and shifts to a corresponding page according to a teacher's directions. Each electronic paper module 130 can store a large quantity of content. The student searches and displays lecture materials included in the content using the digital pen. If the student wishes to take notes during the class, the student can write on a corresponding region of the electronic paper module 130 with the digital pen. The written information is stored in the electronic paper module 130 together with the content.

According to an additional aspect of the present invention, inputted write information is stored in relation to information of a currently displayed page. For example, content of the electronic book may include image and moving picture files, resource files including text files that contain data as to the text description, for example, font type, font size, line pitch, etc., and a script for describing the arrangement of resources. The flash format from Adobe Systems is an example of a well-known open format that may be employed. The inputted write information constructs an independent resource file. The write information may be stored as a bitmap image or as vector graphics, or may be stored by including operation information during writing. In order to store the write information in relation to information of a currently displayed page, a new graphics layer to display the write information is added to an existing graphics layer in the script for describing the arrangement of the resources.

According to another aspect of the present invention, the write panel has a transparent paper form which is attached and detached separately from the electronic paper module 130. In the example embodiment shown in FIG. 1, the write panel 150 is put on the electronic paper module 130 for writing. The write panel 150 may be achieved by, for example, a plastic touch panel.

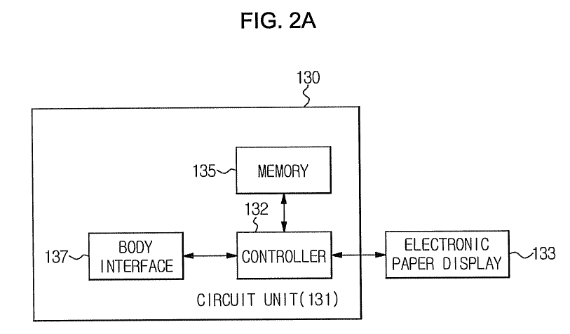

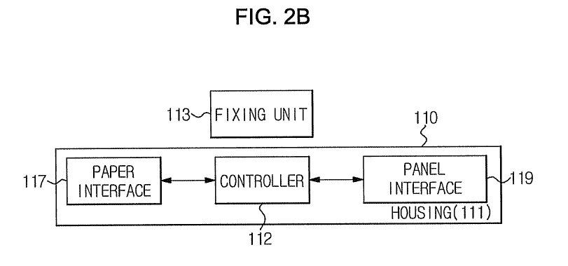

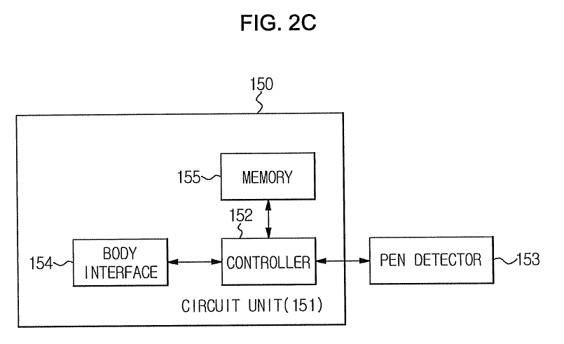

FIG. 2A shows the electronic paper module 130 according to an example embodiment of the present invention. The electronic paper module 130 includes a memory 135 to store content, a body interface 137 to input and output data with the body 110, a controller 132, and an electronic paper display. The controller 132 generates display data by reading the content stored in the memory 135 according to a manipulation command inputted from the body interface 137 and to store write information inputted from the body interface 137 in a corresponding region of the memory 135. The electronic paper display 133 displays the display data generated from the controller 132.

The memory 135 includes a non-volatile memory that can update data, such as a flash memory. The body interface 137 may be the above-described wireless bus interface. The manipulation command inputted through the write panel 150 may include commands to shift to the next page, shift to the previous page, shift to the designated page, control reproduction of moving pictures contained in a specific page, and the like. The controller 132 includes a microprocessor and a program. The electronic paper display 133 employs a display using E-ink or similar technology. Small charged particles surrounded with a microcapsule react to a polarity variation of electrodes printed in a flexible polymer substrate and are moved to change colors of the surface of the electronic paper display 133. An electronic paper technology using quick response-liquid powder display (QR-LPD) can achieve moving pictures since a switching time is fast.

FIG. 2B shows the body 110 corresponding to the electronic paper module 130 of FIG. 2A. The body 110 includes a fixing unit 113 to detachably fix the electronic paper module 130, a plurality of paper interfaces 117 to input and output data with the electronic paper module 130, a panel interface 119 to receive data from the write panel 150, and a controller 112. The controller 112 outputs, through a corresponding one of the paper interfaces 117, write information inputted through the panel interface 119 to be recorded in a corresponding region of the electronic paper module 130.

As shown in FIG. 2, the paper interfaces 117 and the panel interface 119 employ the same wireless bus interface. The controller 112, as a master, recognizes the paper interfaces 117 and the panel interface 119 as two slaves. An application program within the controller 112 distinguishes between the two roles. A dedicated radio communication channel may also be assigned to the panel interface 119 separately from the paper interfaces 117. This means that frequency division or time division can be used. The controller 112 includes a microprocessor and a program.

The body 110 includes a main battery. Near-field wireless transmission of power is performed between the body 110 and the electronic paper modules 130 and between the body 110 and the write panel 150. The wireless transmission of power operates based upon inductive coupling. Any technology for efficient wireless power transmission, such as commercially available applications including wireless cell phone charging, may be employed.

FIG. 2C shows the write panel 150 corresponding to the electronic paper module of FIG. 2A and the body 110 of FIG. 2B. The write panel 150 includes a pen detector 153, a controller 152, a memory 155, and a body interface 154. The pen detector 153 detects movement of a digital pen. The controller 152 generates write data from the movement detected by the pen detector 153. The memory 155 stores a control program and temporal data, and the body interface 154 outputs the write data to the body 110.

The pen detector 153 may be a plastic touch panel. The body interface 154 is a wireless bus interface corresponding to the panel interface 119 of the body 110. The memory 155 stores a control program to drive the pen detector 153, recognize write data, and communicate through the body interface 154. The memory 155 also stores temporal data necessary for recognizing the write data. The controller 152 includes a microprocessor and a program.

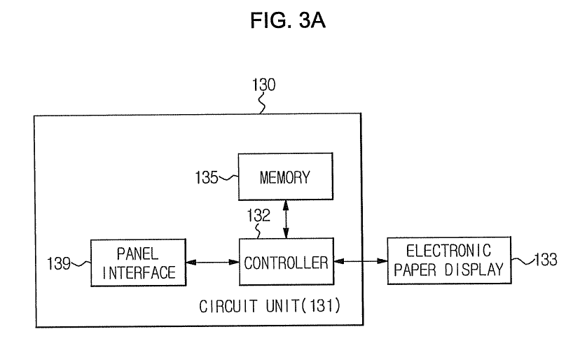

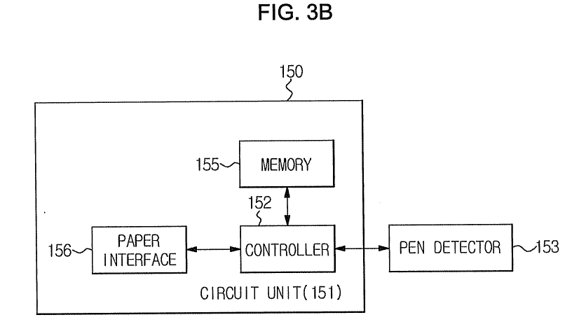

FIG. 3A shows the electronic paper module 130 according to another example embodiment of the present invention. The electronic paper module 130 includes a memory 135, a panel interface 139, a controller 132, and an electronic paper display 132. The memory 135 stores content. The panel interface 139 receives data from the write panel 150. The controller 132 generates display data by reading the content stored in the memory 135 according to a manipulation command inputted from the panel interface 139 and stores write information inputted from the panel interface 139 in a corresponding region of the memory 135. The electronic paper display 133 displays the display data generated from the controller 132.

The example embodiment shown in FIG. 3A is different from the example embodiments shown in FIGS. 2A, 2B, and 2C in that the electronic paper modules 130 interfaces with the write panel 150 directly, without passing through the body 110. Plural write panels may be provided corresponding to the electronic paper modules 130, or one write panel may be used by contacting the electronic paper module to be written upon. However, the example embodiment does not preclude an interface between the body 110 and the electronic paper modules 130 or between the body 110 and the write panel 150. The body 110 may additionally have a network function to update the content of the electronic paper modules 130 or to upgrade the write panel 150.

The body 110 includes a main battery. Near-field wireless transmission of power is performed between the body 110 and the electronic paper modules 130 and between the body 110 and the write panel 150. The wireless transmission of power utilizes inductive coupling, as described above with respect to FIGS. 2A-2C.

The memory 135 includes a non-volatile memory which can update data, such as a flash memory. The panel interface 139 may be the above-described near-field wireless communication interface. It is possible to communicate at a baseband level without modulation using close proximity near-field communication. Low-speed communication in a baseband using inductive coupling or capacitive coupling may also be employed.

The manipulation command inputted through the write panel 150 may include commands to shift to the next page, shift to the previous page, shift to the designated page, control reproduction of moving pictures contained in a specific page, and the like. The controller 132 includes a microprocessor and a program. The electronic paper display 133 employs a display using E-ink or similar technology, as described above.

FIG. 3B shows the write panel 150 corresponding to the electronic paper module of FIG. 3A. The write panel 150 includes a pen detector 153 to detect movement of a digital pen, a controller 152 to generate write data from the movement detected by the pen detector 153, a memory 155 to store a control program and temporal data, and a paper interface 156 to output the write data to the electronic paper module 130.

The pen detector 153 is a plastic touch panel. The paper interface 154 is a near-field wireless communication interface corresponding to the panel interface 139 of the electronic paper module 130. The memory 155 stores a control program to drive the pen detector 153, recognize write data, and communicate through the body interface 154 and stores temporal data necessary for recognizing the write data. The controller 152 includes a microprocessor and a program.

According to another aspect of the present invention, write panels corresponding to the number of electronic paper modules 130 may be fixedly coupled to the electronic paper modules 130. In this case, the pen detector 153 may adhere to the electronic paper display 133 or may be combined with the electronic paper display 133 while sharing a substrate. Further, respective circuit units 131 and 151 may be integrated.

However, only one write panel 150 may be provided, and the write panel 150 may be placed upon the electronic paper module which is to be written upon. In this case, the write panel 150 and the electronic paper module 130 may be arranged by a mark printed on the electronic paper module 130 and/or the write panel 150. In this case, the write panel 150 and the electronic paper module 130 may interface with each other using contactless near-field communication.

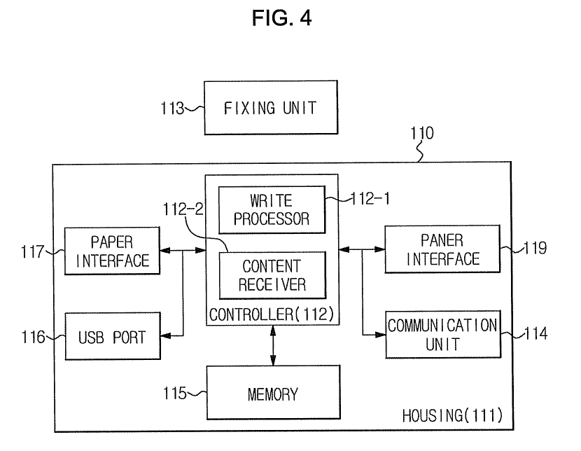

FIG. 4 shows a body 110 according to still another example embodiment of the present invention. The body 110 includes a fixing unit 113 to detachably fix the electronic paper module 130, a memory 115 to store content, a paper interface 117 to input and output data with the electronic paper module 130, a panel interface 119 to receive data from the write panel 150, and a controller 112. The controller 112 outputs, through the paper interface 117, write information inputted through the panel interface 119 and includes a write processor 112-1 to store the write information in relation to currently displayed information in the memory 115.

According to the example embodiment shown in FIG. 4, each electronic paper module 130 requests that the body 110 transmit content to the electronic paper module 130, which then displays the content. Therefore, each electronic paper module 130 has a simple circuit configuration. However, the electronic paper modules 130 may have their own content individually. The respective electronic paper modules 130 store their own unique content in corresponding memories. The electronic paper modules 130 can request the body 110 to transmit additional content or can update their own content through the content stored in the body 110.

According to an additional aspect of the present invention, the controller 112 of the body 110 may further include a content receiver 112-2 that receives content information through a network from a host computer and stores the content information in the memory 115. The body 110 includes a communication unit 114 communicating with an external host computer according to a network protocol, such as the Ethernet protocol. The body 110 can add or update content by downloading content from the host computer. The electronic paper module 130 that is attachable or detachable to or from the body can also add or update content through the body 110.

According to an additional aspect of the present invention, the body 110 may further include a pen container (not shown) in which the digital pen 170 can be stored. The pen container may take the form of an insertion hole formed in a length direction at one side of the body 110.

According to an additional aspect of the present invention, the digital pen 170 may include an external memory, and the body 110 may include a connector connected to the external memory of the digital pen 170. In the example embodiment shown in FIG. 1, the external memory is a part located at an upper side of the digital pen 170 with a thickness different from the thickness of the digital pen 170. The external memory may be attached to or detached from the digital pen 170. The external memory may thus be carried together with the digital pen 170 or may be carried separately from the digital pen 170. An operating system of the body 110 recognizes the external memory through a universal serial bus (USB) port 116 of the body 110. Each electronic paper module 130 can recognize the external memory recognized by the body as its own external memory. Accordingly, the content or write information stored in the memory of the electronic paper module is stored in the external memory so as to be externally used.

According to an additional aspect of the present invention, the digital pen 170 may further include a radio frequency identification (RF-ID) reader. Thus, a user can acquire information stored in, for example, an RF-ID card by using the digital pen 170. The read information is transmitted to the body 110 through a communication interface, such as the USB port 116 shown in FIG. 4 between the digital pen 170 and the body 110. Such a function can be conveniently used, for example, when reading tags attached to historic sites during a field trip and inputting information about the historic site to a user's electronic book.

As is apparent from the above description, the electronic book according to aspects of the present invention has an effect of carrying a plurality of books by a single electronic book binding electronic paper because the electronic paper modules function as one book. Further, since the respective electronic paper modules are attachable and detachable, parts containing only necessary content can be selectively bounded.

Furthermore, it is possible to write in the electronic book and especially it is possible to write on a corresponding page of content of each electronic paper module. Therefore, the inventive electronic book provides much convenience to users, similar to that of a general book. In addition, content of the electronic book can be transferred externally using a digital pen. Moreover, content can be updated or added to the electronic through a network.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, aspects of the present invention, such as the various controllers described above, can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), magnetic tapes, floppy disks, and optical data storage devices including CDs and DVDs. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains. Accordingly, it is intended, therefore, that the present invention not be limited to the various example embodiments disclosed, but that the present invention includes all embodiments falling within the scope of the appended claims.

What is claimed is:

1. A writable electronic book comprising:
a binder body;
a plurality of electronic paper modules, each representing a single sheet of paper detachably coupled to the binder body, to display content;
a write panel that is included in at least one of the electronic paper modules and that overlaps at least part of a display area of the at least one of the electronic paper modules, to receive manipulation information and write information from a user via a digital pen;
wherein the write information inputted through the write panel is added to the content and is stored.

2. The writable electronic book according to claim 1, wherein the write information is stored in relation to information of a currently displayed page on the at least one of the electronic paper modules.

3. The writable electronic book according to claim 1, wherein the write panel is a transparent paper type that is attachable and detachable separately from the electronic paper modules.

4. The writable electronic book according to claim 3, wherein each of the electronic paper modules comprises:
a memory to store the content;
a body interface to input data to the electronic paper module and output data to the binder body;
a controller to generate display data by reading the content stored in the memory according to a manipulation command inputted from the body interface and to store write information inputted from the body interface in a corresponding region of the memory; and
an electronic paper display to display the display data generated from the controller.

5. The writable electronic book according to claim 4, wherein the binder body comprises:
a fixing unit to attach and detach the electronic paper modules to and from the binder body;
a plurality of paper interfaces to input data to, and output data from, the electronic paper modules;
a panel interface to receive data from the write panel; and
a body controller to output, through a corresponding one of the paper interfaces write information inputted through the panel interface to be recorded in a corresponding region of the electronic paper module.

6. The writable electronic book according to claim 5, wherein the write panel comprises:
a pen detector to detect movement of a digital pen;
a write panel controller to generate write data from the movement detected by the pen detector;
a write panel memory to store a control program and temporal data; and
a write panel interface to output the write data to the binder body.

7. The writable electronic book according to claim 6, wherein the body interface, the panel interface, and the write panel interface are operated by wireless bus interfaces.

8. The writable electronic book according to claim 3, wherein each of the electronic paper modules comprises:
a memory to store the content;
a panel interface to receive data from the write panel;
a controller to generate display data by reading the content stored in the memory according to a manipulation command inputted from the panel interface and to store write information inputted from the panel interface in a corresponding region of the memory; and
an electronic paper display to display the display data generated from the controller.

9. The writable electronic book according to claim 8, wherein the transparent write panel comprises:
a pen detector to detect movement of the digital pen;
a write panel controller to generate write data from the movement detected by the pen detector;
a write panel memory to store a control program and temporal data; and
a paper interface to output the write data to the electronic paper modules.

10. The writable electronic book according to claim 9, wherein the paper interface and the panel interface are both a contactless near-field communication interface.

11. The writable electronic book according to claim 9, wherein a plurality of transparent write panels are fixedly coupled to the electronic paper modules.

12. The writable electronic book according to claim 1, wherein the binder body comprises:
a fixing unit to detachably couple the electronic paper module to the binder body;
a memory to store the content;
a paper interface to input data to, and output data from, the electronic paper module;
a panel interface to receive data from the write panel; and
a controller to output, through the paper interface, write information inputted through the panel interface and including a write processor to store the write information in relation to currently displayed information in the memory.

13. The writable electronic book according to claim 12, wherein the controller of the binder body further includes a content receiver to receive content information from a host computer through a network and to store the content information in the memory.

14. The writable electronic book according to claim 1, wherein the binder body further includes a pen container in which the digital pen is stored.

15. The writable electronic book according to claim 14, wherein:
the digital pen includes an external memory; and
the binder body includes a connector connected to the external memory of the digital pen.

16. The writable electronic book according to claim 14, wherein the digital pen further includes a radio frequency identification (RF-ID) reader.

17. An electronic book comprising:
a binder body;
at least one electronic paper module detachably coupled to the binder body to display content to a user; and
at least one write panel arranged so as to overlap at least a portion of a corresponding one of the at least one electronic paper module, to receive input from the user.

18. The electronic book of claim 17, wherein each of the at least one write panel is integrated with the corresponding one of the at least one electronic paper module.

19. The electronic book of claim 17, wherein the at least one write panel comprises one write panel detachably coupled to one of the at least one electronic paper module.

20. The electronic book of claim 17, further comprising:
a cable to couple the at least one electronic paper module to the binder body and to couple the at least one write panel to the binder body; and
wherein the at least one write panel communicates with the corresponding one of the at least one electronic paper module via the cable and the binder body.

21. The electronic book of claim 17, wherein:
each of the at least one electronic paper module comprises a panel interface to communicate with a corresponding one of the at least one write panel without communicating via the binder body; and
each of the at least one write panel comprises a paper interface to communicate with the corresponding one of the at least one electronic paper module without communicating via the binder body.

22. The electronic book of claim 17, wherein the binder body comprises:
a fixing unit to which each of the at least one electronic paper module is detachably coupled;
a paper interface to communicate with the at least one electronic paper module;
a panel interface to communicate with the at least one write panel; and
a controller to control the at least one electronic paper module and the at least one write panel via the paper interface and the panel interface, respectively.

23. The electronic book of claim 22, wherein the binder body further comprises:
a network communication unit to communicate with a network.

24. The electronic book of claim 23, wherein:
the binder body receives an update to the at least one electronic paper module via the network communication unit; and
the controller updates the at least one electronic paper module based on the update, via the paper interface.
